(19) United States
(12) Patent Application Publication
(10) Pub. No.: US 2026/0129227 A1
(43) Pub. Date: May 7, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yingzhan XU, Beijing (CN); Kai ZHANG, Los Angeles, CA (US); Li ZHANG, Los Angeles, CA (US)

(21) Appl. No.: 19/440,383

(22) Filed: Jan. 5, 2026

Related U.S. Application Data
(63) Continuation of application No. PCT/CN2024/104075, filed on Jul. 5, 2024.

(30) Foreign Application Priority Data
Jul. 6, 2023 (WO) PCT/CN2023/106204

(51) Int. Cl. H04N 19/54; H04N 19/105; H04N 19/159; H04N 19/196

(52) U.S. Cl. CPC H04N 19/54; H04N 19/105; H04N 19/159; H04N 19/198

(57) ABSTRACT

Embodiments of the present disclosure provide a solution for video processing. A method for video processing is proposed. The method comprises: performing a conversion between a current point cloud (PC) sample of a point cloud sequence and a bitstream of the point cloud sequence, wherein the bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

### CROSS REFERENCE TO RELATED APPLICATIONS

This application is a continuation of International Application No. PCT/CN2024/104075, filed on Jul. 5, 2024, which claims the benefit of International Application No. PCT/CN2023/106204 filed on Jul. 6, 2023. The entire contents of these applications are hereby incorporated by reference in their entireties.

### FIELDS

Embodiments of the present disclosure relate generally to video processing techniques, and more particularly, to attribute prediction based on region-adaptive hierarchical transform (RAHT).

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency and coding quality of conventional point cloud coding techniques is generally expected to be further improved.

### SUMMARY

Embodiments of the present disclosure provide a solution for video processing.

In a first aspect, a method for video processing is proposed. The method comprises: performing a conversion between a current point cloud (PC) sample of a point cloud sequence and a bitstream of the point cloud sequence, wherein the bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

Based on the method in accordance with the first aspect of the present disclosure, the bitstream comprises an indication indicating an attribute prediction scheme(s) that is used and/or available for one or more nodes in the current PC sample that are at a first level lower than a sequence level. Compared with the conventional solution where information regarding the usage of attribute prediction scheme(s) is signaled at sequence level, the proposed method can advantageously signal such information at a lower level, and enable a refined control of the usage of attribute prediction scheme(s). Thereby, the coding efficiency and coding quality can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a point cloud sequence which is generated by a method performed by an apparatus for video processing. The method comprises: performing a conversion between a current point cloud (PC) sample of the point cloud sequence and the bitstream, wherein the bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

In a fifth aspect, a method for storing a bitstream of a point cloud sequence is proposed. The method comprises: performing a conversion between a current point cloud (PC) sample of the point cloud sequence and the bitstream; and storing the bitstream in a non-transitory computer-readable recording medium, wherein the bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure:

FIG. 3 illustrates a block diagram that illustrates an example point cloud decoder, in accordance with some embodiments of the present disclosure:

FIG. 4 illustrates parent-level nodes for each sub-node of transform unit node:

FIG. 5 illustrates a flowchart of an example process of attribute prediction in RAHT in accordance with embodiments of the present disclosure:

FIG. 6 illustrates a flowchart of a method for video processing in accordance with embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

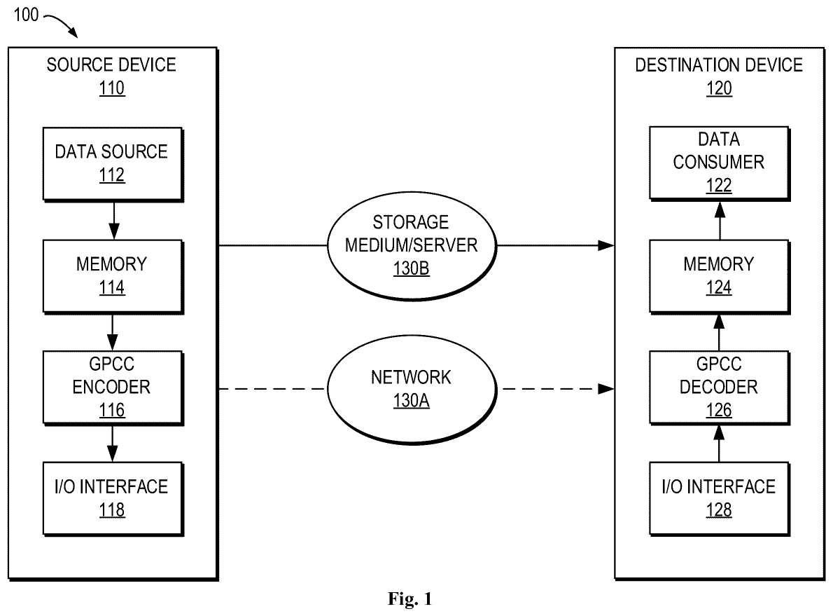

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure. GPCC encoder 116 of source device 100 and GPCC decoder 126 of destination device 120) may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case. GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components. I/O interface 118 and I/O interface 128 may be configured to transfer data, such as encoded point cloud data, according to a cellular communication standard, such as 4G. 4G-LTE (Long-Term Evolution). LTE Advanced, 5G. or the like. In some examples where I/O interface 118 comprises a wireless transmitter. I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

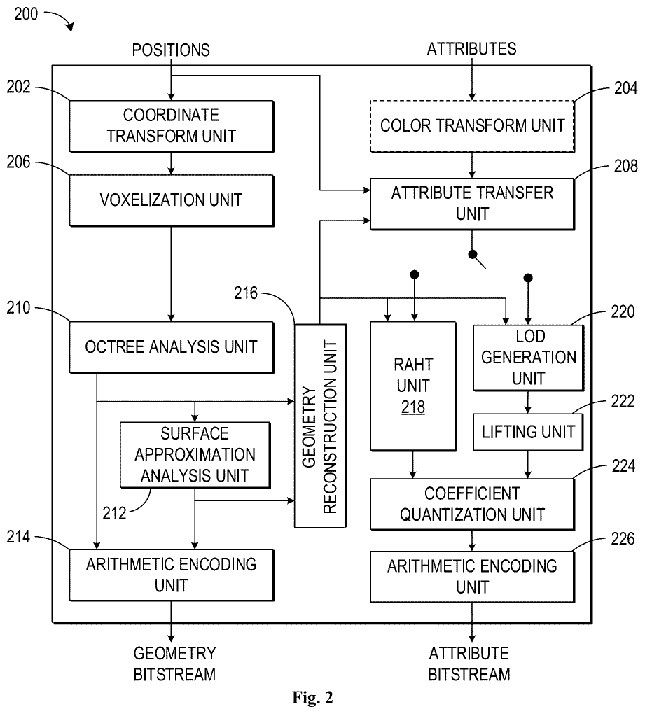

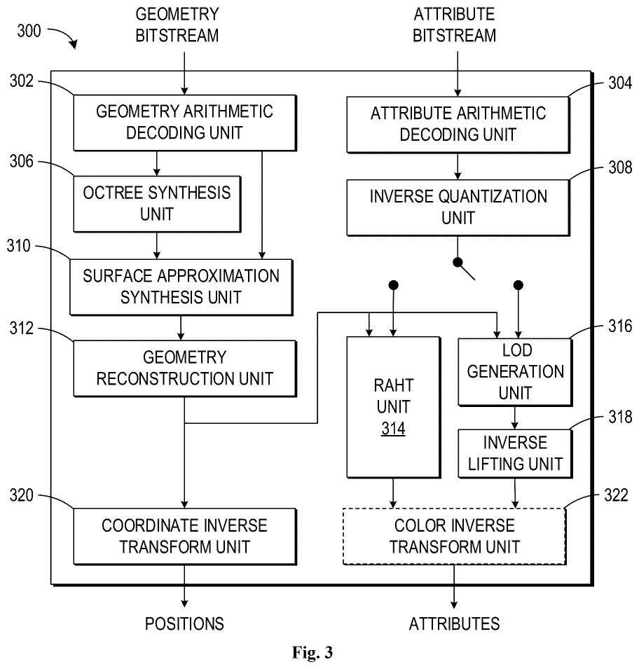

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212. RAHT unit 314 and surface approximation synthesis unit 310 are options typically used for Category 1 data. The level-of-detail (LOD) generation unit 220, lifting unit 222. LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2. GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2. GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel.” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore. RAHT unit 218 may apply RAHT coding to the attributes of the reconstructed points. Alternatively or additionally. LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3. GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded. RAHT unit 314 may perform RAHT coding to determine, based on the inverse quantized attribute values, color values for points of the point cloud. Alternatively. LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Introduction

The present disclosure is related to point cloud coding technologies. Specifically, it is related to point cloud attribute inter prediction in region-adaptive hierarchical transform. The ideas may be applied individually or in various combination, to any point cloud coding standard or non-standard point cloud codec, e.g., the being-developed Geometry based Point Cloud Compression (G-PCC).

### 2. Abbreviations

G-PCC Geometry based Point Cloud Compression
MPEG Moving Picture Experts Group
3DG 3D Graphics Coding Group
CFP Call For Proposal
V-PCC Video-based Point Cloud Compression
RAHT Region-Adaptive Hierarchical Transform

### 3. Background

MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Region-Adaptive Hierarchical Transform

In G-PCC, one of important point cloud attribute coding tools is the Region-Adaptive Hierarchical Transform (RAHT). It is a transform that uses the attributes associated with a node in a lower level of the octree to predict the attributes of the nodes in the next level. It assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y then x). If there are L levels in octree, RAHT takes 3L levels to traverse the tree backwards.

Let the nodes at level l be g_{l,x,y,z}, for x, y, z integers, g_{l,x,y,z} was obtained by grouping g_{l+1,2x,y,z} and g_{l+1,2x+1,y,z}, where the grouping along the first dimension was an example RAHT only process occupied nodes. If one of the nodes in the pair is unoccupied, the other one is promoted to the next level, unprocessed, i.e., g_{l-1,x,y,z}=g_{l,2x,y,z} if the latter is the occupied node of the pair. The grouping process is repeated until getting to the root. Note that the grouping process generates nodes at lower levels that are the result of grouping different numbers of voxels along the way. The number of nodes grouped to generate node g_{l,x,y,z} is the weight w_{l,x,y,z} of that node.

At every grouping of two nodes, say g_{l,2x,y,z} and g_{l,2x+1,y,z}, with their respective weights, ω_{l,2x,y,z} and ω_{l,2x+1,y,z}, RAHT apply the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

where ω₁=ω_{l,2x,y,z} and ω₂=ω_{l,2x+1,y,z} and

$${T}_{{ω}_{1} {ω}_{2}} = \frac{1}{\sqrt{{ω}_{1} {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level, h_{l,x,y,z} are the actual high-pass coefficients generated by the transform to be encoded and transmitted. Furthermore, weights accumulate for the level above. In the above example,

$${ω}_{l - 1 , 2 , y , z} = {ω}_{l , 2 x , y , z} + {ω}_{l , 2 x + 1 , y , z} .$$

In the last stage, the tree root, the remaining two voxels g_{1,0,0,0} and g_{1,1,0,0} are transformed into the final two coefficients as:

$$[ \begin{matrix}{g}_{D C} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ]$$

where g_{DC}=g_{0,0,0,0}.

### 3.3 Upsampled Transform Domain Prediction in RAHT

The transform domain prediction is introduced to improve coding efficiency on RAHT. It is formed of two parts.

Firstly, the RAHT tree traversal is changed to be descent based from the previous ascent approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root.

Secondly, for each sub-node of transform unit, a corresponding predicted sub-node is produced by upsampling the previous transform level. Actually, only sub-node that contains at last one point will produce a corresponding predicted sub-node. The transform unit that contains 2×2×2 predicted sub-nodes is transformed and subtracted from the transformed attributes at the encoder side.

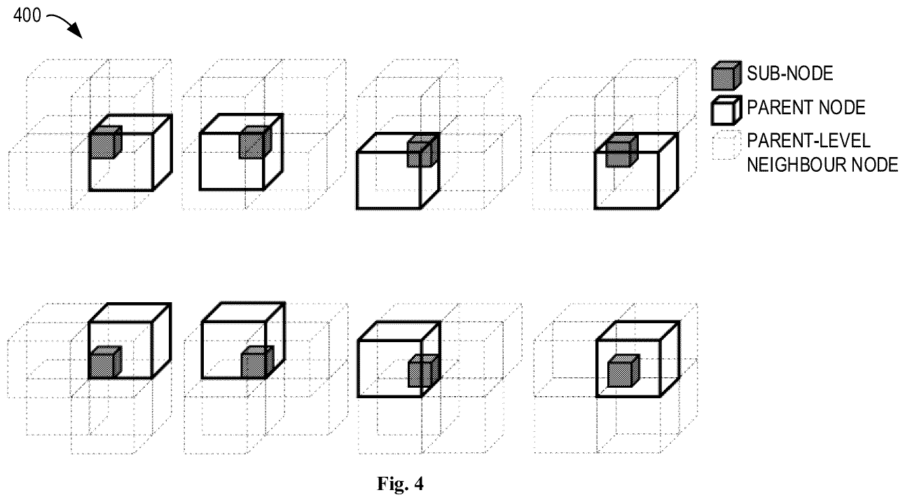

Each sub-node of transform unit node is predicted by 7 parent-level nodes where 3 coline parent-level neighbour nodes, 3 coplane parent-level neighbour nodes and 1 parent node. Coplane and coline neighbours are the neighbours that share a face and an edge with current transform unit node, respectively. FIG. 4 shows 7 parent-level nodes for each sub-node of transform unit node.

The attribute aᵤₚ of each sub-node is predicted depending on the distance between it and its parent-level node as follows:

$${a}_{u p} = \sum {ω}_{k} {a}_{k} / \sum {ω}_{k}$$

where aₖ is the attribute of its one parent-level node and ωₖ is weight depending on the distance. In G-PCC, ωₚₐᵣₑₙₜ:ω_{coplane}:ω_{coline}=4:2:1.

For AC coefficient, the prediction residual will be signalled.

For DC coefficient, the coefficients are inherited from the previous level, which means that the DC coefficient is signalled without prediction.

### 3.4 Attribute Inter Prediction in RAHT

The attribute inter prediction in RAHT was proposed and researched. It is proposed to apply inter-prediction to DC and AC coefficients in RAHT. The same octree decomposition is performed on the current frame and the reference frame.

For the first 5 layers, the same scan of the octree is performed on the two frames. Before performing the octree scan backwards, a point-to-point matching process needs to be performed to ensure that the node of the reference frame can establish a corresponding one-to-one relationship with the node of the current frame. For each point in the reference frame, it will be matched to one point in the current frame in a “upper matching” method. The Morton value of the matched point is the smallest Morton value greater than the Morton value of the current point.

For DC coefficients, the residual between the DC coefficient for the root node of the current frame and the DC coefficient for the root node of the reference frame is calculated as:

$$D {C}_{r e s i d u a l} = D {C}_{c u r r e n t} - D {C}_{reference} .$$

The DC_{residual} is signaled to the decoder in place of DC_{current}.

For each node in the first 5 layers, the average attribute of the node in the same octree location in the reference frame is calculated as Attr_{predicted_inter} and the corresponding AC coefficients are calculated as A_{Cpredicted_inter}.

For AC coefficients, the prediction residual is signalled as:

$$A {C}_{r e s i d u a l} = A {C}_{c u r r e n t} - A {C}_{p r e d i c t e d} ,$$

$$A {C}_{p r e d i c t e d} = A {C}_{predicted\_inter} ? A {C}_{predicted\_inter} : A {C}_{predicted\_intra} .$$

If the AC_{predicted_inter} is equal to zero, the AC_{predicted_intra} is applied as the original transform domain prediction.

### 4. Problems

The existing designs for point cloud attribute prediction in RAHT have the following problems:

1. In current design, the prediction result is either inter prediction value or intra prediction value. However, for some nodes, neither the inter prediction value nor intra prediction value is the optimal prediction value. For example, for some nodes, the mean value of inter and intra prediction value may outperform the other prediction values.

2. In current design, a point-to-point “up-matching” process needs to be performed to ensure that the node in the reference frame can establish a corresponding one-to-one relationship with the node in the current frame. However, for some nodes in the current frame, the matched nodes in the reference frame may be empty. In this case, the prediction efficiency may be limited.

### 5. Detailed Solutions

To solve the above problems and some other problems not mentioned, methods as summarized below are disclosed. The solutions should be considered as examples to explain the general concepts and should not be interpreted in a narrow way. Furthermore, these solutions can be applied individually or combined in any manner.

It should be noticed that in the following discussions, the term RAHT may represent the current RAHT design or any variance of the current RAHT design.

1) It is proposed to perform the AC prediction (inter- and/or intra-prediction) in one specific domain.
a. In one example, the specific domain may be transform domain.
   i. In one example, the predicted value and the current value may be in the form of AC coefficients.
b. In one example, the specific domain may be attribute domain.
   i. In one example, the predicted value and the current value may be in the form of average attribute value/whole attribute value, and so on.
   ii. In one example, the predicted value and the current value may be in the form of conversion of average attribute value/whole attribute value, and so on. For example, the conversion may be normalization.
c. In one example, there may be one indication to indicate which domain the prediction is performed.
   i. In one example, the prediction may be performed in transform domain if the indication is equal to one value; otherwise, the prediction may be performed in attribute domain.
   ii. In one example, the prediction may be performed in transform domain if the indication is not equal to one value; otherwise, the prediction may be performed in attribute domain.
   iii. In one example, the indication may be signalled.
   iv. In one example, the indication may be pre-defined.
d. In one example, the prediction value of AC (e.g., the AC_{predicted} in section 3.4) may be calculated from the AC inter prediction (e.g., the AC_{predicted_inter} in section 3.4) and/or the AC intra prediction (e.g., the AC_{predicted_intra} in section 3.4).
   i. In one example, the prediction value may be set to the mean or max or min of the AC inter and intra prediction.
e. In one example, the prediction value may be set to the weighted sum (mean) of the AC inter (e.g., the AC_{predicted_inter} in section 3.4) and AC intra prediction (e.g., the AC_{predicted_intra} in section 3.4) or using a non-linear function with weights as input parameters.
   i. In one example, the weights may be fixed at the encoder and the decoder.
   ii. Alternatively, the weights may be derived at the encoder and the decoder.
   iii. Alternatively, indications of the weights may be signalled to the decoder (e.g., in different levels, such as depth layer/region/frame level).
   iv. In one example, the weights may be different for different depth layer.
   v. In one example, the weights may be different for different region.
f. In one example, it is proposed to perform the AC inter prediction in transform domain.
   i. In one example, the prediction residual of transform results (e.g., AC coefficients) may be signalled.
   ii. In one example, the prediction residual of transform results (e.g., AC coefficients) may be processed before being signalled.
      1. In one example, the processing may be quantization.
g. In one example, AC_{predicted_inter} may be the transform results of the predicted attributes of the reference node in the reference frame.
   i. In one example, the predicted attributes of the reference node may be derived based on the reconstructed attributes and reconstructed geometry of the reference frame.
      1. In one example, the predicted attributes of the reference node may be represented by the predicted attribute of each sub node of the reference node.
      2. In one example, the predicted attributes of one reference node may be the average attributes of the sub-nodes of the reference node.
h. Alternatively, AC_{predicted_inter} may be the reconstructed AC coefficients of the reference node in the reference frame.
i. In one example, AC_{predicted} may be processed before being used as a prediction.
   i. In one example, the processing may be dequantization.

2) It is proposed to perform the DC prediction (inter- and/or intra-prediction) in one specific domain.
a. In one example, the specific domain may be transform domain.
   i. In one example, the predicted value and the current value may be in the form of DC coefficients.
b. In one example, the specific domain may be attribute domain.
   i. In one example, the predicted value and the current value may be in the form of average attribute value/whole attribute value, and so on.
   ii. In one example, the predicted value and the current value may be in the form of conversion of average attribute value/whole attribute value, and so on. For example, the conversion may be normalization.
c. In one example, there may be one indication to indicate which domain the prediction is performed.
   i. In one example, the prediction may be performed in transform domain if the indication is equal to one value; otherwise, the prediction may be performed in attribute domain.
   ii. In one example, the prediction may be performed in transform domain if the indication is not equal to one value; otherwise, the prediction may be performed in attribute domain.
   iii. In one example, the indication may be signalled.
   iv. In one example, the indication may be pre-defined.
d. In one example, the prediction value of DC coefficients of all nodes in the current octree may be calculated from the DC inter prediction value.
e. In one example, the prediction value of DC coefficients of partial nodes in the current octree may be calculated from the DC inter prediction value.
f. In one example, the prediction value of DC coefficients of the first node in the current octree may be calculated from the DC inter prediction value.
g. In one example, it is proposed to perform the DC inter prediction in transform domain.
   i. In one example, the prediction residual of transform results (e.g., DC coefficients) may be signalled.
   ii. In one example, the prediction residual of transform results (e.g., DC coefficients) may be processed before being signalled.
      1. In one example, the processing may be quantization.
h. In one example, the DC inter prediction value may be the transform results of the predicted attributes of the reference node in the reference frame.
   i. In one example, the predicted attributes of the reference node may be derived based on the reconstructed attributes and reconstructed geometry of the reference frame.
      1. In one example, the predicted attributes of the reference node may be represented by the predicted attribute of each sub node of the reference node.
      2. In one example, the predicted attributes of one reference node may be the average attributes of the sub-nodes of the reference node.
i. Alternatively, the DC inter prediction value may be the reconstructed DC coefficients of the reference node in the reference frame.
j. In one example, the DC inter prediction value may be processed before being used as a prediction.
   i. In one example, the processing may be dequantization.

3) It is proposed to apply different octree decomposition to the current frame and the reference frame.
a. In one example, how to do the octree decomposition of a frame may be signaled to the decoder.
   i. In one example, there may be one indication to indicate whether the same octree decomposition is applied to the current frame and the reference frame.
   ii. In one example, the indication may be signalled.
   iii. In one example, the indication may be pre-defined.
b. In one example, the octree decomposition of the current frame may be determined by the geometry information of the current frame.
c. In one example, the octree decomposition of the reference frame may be determined by the geometry information of the reference frame.
d. In one example, for each node in the current frame, there may be at most one reference node in the reference frame.
   i. In one example, there may be one reference node if the reference node and the current node share the same octree location and the reference node is not empty; otherwise, there is no reference nodes for the current node.
   ii. Alternatively, there may be one reference node if the reference node and the current node share the same octree location; otherwise, there is no reference nodes for the current node.
   iii. In one example, there may be one reference node is the reference node and the current node share the same spatial location and the reference node is not empty; otherwise, there is no reference nodes for the current node.
      1. In one example, the spatial location may be represented by the Morton code of one node.
      2. Alternatively, the spatial location may be represented by the shifted Morton code of one node.
   iv. Alternatively, there may be one reference node is the reference node and the current node share the same spatial location; otherwise, there is no reference nodes for the current node.

4) It is proposed to apply the AC and/or DC inter prediction conditionally for one node in the current frame.
a. In one example, the inter prediction may be applied to the current node when there is one reference node in the reference frame.
b. In one example, the inter prediction may be applied to the current node when more than of one of the sub nodes of the current node are occupied.
   i. In one example, one sub-node may be occupied if there are at least one points in the sub-node.
c. In one example, the inter prediction may be applied to the current node when the intra prediction is enabled for the current node.
d. In one example, the inter prediction may be applied to the current node when the inter prediction is enabled for the octree layer that the current node belongs to.
e. In one example, the inter prediction may be applied to the current node when all or partial of the above conditions are met.

5) Whether to disable the AC and/or DC intra prediction may be determined on-the-fly.
a. In one example, it is proposed to disable the AC and/or DC intra prediction when the inter prediction is applied and the intra prediction value is determined to be not used.
b. In one example, it is proposed to disable the AC and/or DC intra prediction when the intra prediction value is not used to generate the final prediction value.
c. In one example, the number of neighbor nodes of the current node, which is generated in the intra prediction process, may be set to one specific value when the intra prediction is disabled.

6) It is proposed to apply the AC and/or DC intra prediction conditionally for one node in the current frame.
a. In one example, the intra prediction may be applied to the current node when the intra prediction is enabled for the current node.
b. In one example, the intra prediction may be applied to the current node when the inter prediction is not applied to the current node.
c. In one example, the intra prediction may be applied to the current node when the octree occupancy code of the reference node is not equal to the octree occupancy code of the current node.
d. In one example, the intra prediction may be applied to the current node when all or partial of the above conditions are met.

7) It is proposed to apply the prediction conditionally for one sub node of the current node.
a. In one example, the inter prediction may be applied to one sub node of the current node if the inter prediction is applied to the current node and there is reference sub node in the reference frame.
b. In one example, the intra prediction may be applied to one sub node of the current node when the intra prediction is applied to the current node and the inter prediction is not applied to the current sub node.
c. In one example, the intra prediction may be applied to one sub node of the current node when the intra prediction is applied to the current node.

8) It is proposed to generate the predicted value based on the inter prediction value and/or the intra prediction in RAHT on sets of layers of the octree scan.
a. In one example, the AC and/or DC predicted value may be generated based on the intra prediction value if there is no reference node in the reference frame for the current node. The reference node and the current node share the same octree location.
b. In one example, the AC and/or DC predicted value may be generated based on the intra prediction value on a set of layers of the octree scan.
   i. In one example, the set of layers may be the last M layers of the octree scan.
      1. In one example, M may be signalled to the decoder.
         a. In one example, M may be coded with fixed-length coding, unary coding, truncated unary coding, etc, al.
         b. In one example, M may be coded in a predictive way.
      2. Alternatively, M may be pre-defined.
   ii. Alternatively, the set of layers may be all layers except the first M layers of the octree scan.
      1. In one example, M may be signalled to the decoder.
         a. In one example, M may be coded with fixed-length coding, unary coding, truncated unary coding, etc, al.
         b. In one example, M may be coded in a predictive way.
      2. Alternatively, M may be pre-defined.
c. In one example, the AC and/or DC predicted value may be generated based on the inter prediction and the intra prediction value on a set of layers of the octree scan.
   i. In one example, the set of layers may be the first N layers of the octree scan.
      1. In one example, N may be signalled to the decoder.
         a. In one example, N may be coded with fixed-length coding, unary coding, truncated unary coding, etc, al.
         b. In one example, N may be coded in a predictive way.
      2. Alternatively, N may be pre-defined.
   ii. In one example, the AC and/or DC predicted value may be the transform results of the predicted attributes.
      1. In one example, the predicted attributes may be indicated by the predicted attribute of each sub node of the current node.
      2. In one example, the predicted attribute of one sub node may be the intra prediction value.
      3. Alternatively, the predicted attribute of one sub node may be the inter prediction value.
      4. In one example, the predicted attribute of one sub node may be the inter prediction value of the sub node, if the inter prediction value of the sub node is not equal to zero; otherwise, the predicted attribute of the sub node may be the intra prediction value of the sub node.
      5. In one example, the predicted attributes of all sub nodes may be the inter prediction values of all sub nodes, if there is reference node; otherwise, the predicted attributes of all sub nodes may be the intra prediction values of all sub nodes.
   iii. In one example, the AC predicted value may be the reconstructed AC coefficients of the reference node in the reference frame, if there is reference node; otherwise, the AC predicted value may be the transform results of the intra predicted attributes.
   iv. In one example, the DC predicted value may be the reconstructed DC coefficients of the reference node in the reference frame, if there is reference node; otherwise, the DC predicted value may be the transform results of the intra predicted attributes.
d. In one example, the AC and/or DC predicted value may be generated based on a combination of the inter prediction and the intra prediction value.
   i. In one example, the AC and/or DC predicted value may be the weighted average value of the inter prediction and the intra prediction value on a set of layers of the octree scan.
   ii. In one example, the set of layers may be from the N+1th layer to the Mth layer of the octree scan.
      1. In one example, N and M may be signalled to the decoder.
         a. In one example, N and M may be coded with fixed-length coding, unary coding, truncated unary coding, etc, al.
         b. In one example, N and M may be coded in a predictive way.
      2. Alternatively, N and M may be pre-defined.
   iii. In one example, the AC and/or DC predicted value may be the transform results of the predicted attributes.
      1. In one example, the predicted attributes may be indicated by the predicted attribute of each sub node of the current node.
      2. In one example, the predicted attribute of one sub node may be the intra prediction value.
      3. Alternatively, the predicted attribute of one sub node may be the weighted average value of inter prediction value and intra prediction value.
      4. In one example, the predicted attribute of one sub node may be weighted average value of inter prediction value and intra prediction value of the sub node, if the inter prediction value of the sub node is not equal to zero; otherwise, the predicted attribute of the sub node may be the intra prediction value of the sub node.
      5. In one example, for all sub nodes, the predicted attributes may be the weighted average value of inter prediction value and intra prediction value, if there is reference node: otherwise, the predicted attributes of all sub nodes may be the intra prediction values of all sub nodes.
   iv. In one example, the AC predicted value may be the weighted average value of the reconstructed AC coefficients of the reference node in the reference frame and the transform results of the intra predicted attributes, if there is reference node; otherwise, the AC predicted value may be the transform results of the intra predicted attributes.
   v. In one example, the DC predicted value may be the weighted average value of the reconstructed DC coefficients of the reference node in the reference frame and the transform results of the intra predicted attributes, if there is reference node: otherwise, the DC predicted value may be the transform results of the intra predicted attributes.
   vi. In one example, the weighted average of A and B may be calculated as:

$${Average}_{weight} = \frac{{w}_{inter} \times A + {w}_{intra} \times B}{{w}_{inter} + {w}_{intra}} .$$

1. In one example, A may be the inter prediction value of one sub node and B may be the intra prediction of the one node.
2. In one example, A may be the reconstructed AC and/or DC coefficients of the reference node in the reference frame and B may be the transform results of the intra predicted attributes.
vii. In one example, the weights of inter prediction and intra prediction may be derived at the encoder.
viii. In one example, the weights of inter prediction and intra prediction may be derived at the decoder.
ix. In one example, the weights of inter prediction and intra prediction may be determined by the current layer L where the current node is in.
   1. In one example, the weight of inter prediction is higher and the weight of intra prediction is lower when the current node is in a lower layer of the octree.
   2. In one example, the weight of inter prediction may be calculated as:

$${w}_{i n t e r} = M - L + 1 .$$

3. In one example, the weight of intra prediction may be calculated as:

$${w}_{i n t r a} = L - N .$$

x. In one example, the weights of inter prediction and intra prediction may be signalled to the decoder.
   1. In one example, the weights of inter prediction and intra prediction of each layer maybe signalled to the decoder.
   2. In one example, the weights of inter prediction and intra prediction may be coded with fixed-length coding, unary coding, truncated unary coding, etc, al.
   3. In one example, the weights of inter prediction and intra prediction may be coded in a predictive way.
e. In one example, multiple ways of using inter and intra prediction results and/or multiple ways of layers to be utilized may be enabled.
   i. Alternatively, furthermore, which way (e.g., which layers, weights) to be applied may be pre-defined.
   ii. Alternatively, furthermore, which way (e.g., which layers, weights) to be applied may be signalled.
   iii. Alternatively, furthermore, which way (e.g., which layers, weights) to be applied may be derived on-the-fly.

9) It is proposed to store the reconstructed coefficients when the transform is performed.
a. In one example, for each node, there may be at least one indication to indicate the node location.
   i. In one example, there may be one indication to indicate the octree location of the node.
   ii. In one example, there may be one indication to indicate the octree layer of the node.
b. In one example, the indication may be derived at the encoder.
c. In one example, the indication may be derived at the decoder.
d. In one example, the indication may be corresponding to the reconstructed coefficients of each node.
e. In one example, the indication and the corresponding reconstructed coefficients may be stored in one list.
f. In one example, the reconstructed coefficients may be selected based on the indication from the list when the inter prediction is enabled.

10) It is proposed to signal the method to determine the inter prediction value.
a. In one example, there may be multiple methods to determine the inter prediction value.
   i. In one example, there may be multiple methods to determine the inter prediction value in transform domain.
      1. In one example, the inter prediction value in transform domain may be derived from the reconstructed coefficients of the reference node.
      2. In one example, the inter prediction value in transform domain may be derived from the transform result of the inter predicted attribute.
b. In one example, there may be one indication to indicate the method to determine the inter prediction value.
   i. In one example, there may be one specific value of indication, for each method to determine the inter prediction value.
c. In one example, the indication may be derived at the encoder.
d. In one example, the indication may be signalled to the decoder.
   i. In one example, the indication may be coded with fixed-length coding, unary coding, truncated unary coding, etc, al.
   ii. In one example, the indication may be coded in a predictive way.

11) It is proposed to signal the method/s to determine the prediction value.
a. In one example, there may be multiple methods to determine the prediction value.
   i. In one example, the prediction value may be from inter prediction.
   ii. In one example, the prediction value may be from intra prediction.
   iii. In one example, the prediction value may be from the weighted average of inter prediction and intra prediction.
b. In one example, the prediction value may be from the results of set of prediction method.
   i. In one example, the prediction value may be from inter prediction if the inter prediction value is not zero; otherwise, the prediction value may be from intra prediction.
   ii. In one example, the prediction value may be from inter prediction if the inter prediction is enabled; otherwise, the prediction value may be from intra prediction.
   iii. In one example, the prediction value may be from the weighted average of inter prediction and intra prediction if the inter prediction value is not zero; otherwise, the prediction value may be from intra prediction.
   iv. In one example, the prediction value may be from the weighted average of inter prediction and intra prediction if the inter prediction value and intra prediction value are not zero; otherwise, the prediction value may be from intra prediction value if the intra prediction value is not zero; otherwise, the prediction value may be from inter prediction value.
c. In one example, there may be at least one indication to indication which prediction methods are applied for one sequence.
d. In one example, there may be at least one indication to indication which prediction methods are applied for one region.
e. In one example, there may be at least one indication to indication which prediction methods are applied for one depth layer.
f. In one example, the above indication/s may be fixed at the encoder and the decoder.
g. In one example, the above indication/s may be derived at the encoder and the decoder.
h. In one example, the above indication/s may be derived at the encoder.
   i. In one example, the motion information may be used to determine the indication.
   ii. In one example, the method to generate the prediction value from the weighted average of inter prediction and intra prediction may be disabled when the motion is smaller than one threshold.
i. In one example, the above indication/s may be signalled to the decoder.

12) Whether to and/or how to apply a method disclosed above may be signaled from encoder to decoder in a bitstream/frame/tile/slice/octree/etc.

13) Whether to and/or how to apply the disclosed methods above may be dependent on coded information, such as dimensions, colour format, colour component, slice/picture type.

### 6. Embodiments

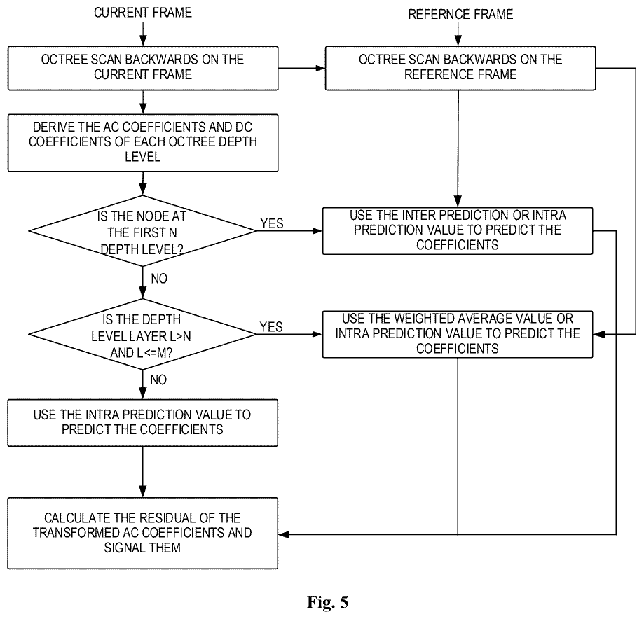

An example of the coding flow for the improved inter prediction of AC coefficients is depicted in FIG. 5. FIG. 5 illustrates an example of the improved attribute prediction in RAHT.

More details of the embodiments of the present disclosure will be described below which are related to prediction for point cloud attribute coding based on the region-adaptive hierarchical transform (RAHT). The embodiments of the present disclosure should be considered as examples to explain the general concepts and should not be interpreted in a narrow way. Furthermore, these embodiments can be applied individually or combined in any manner.

As used herein, the term “point cloud sequence” may refer to a sequence of one or more point clouds. The term “point cloud frame” or “frame” may refer to a point cloud in a point cloud sequence. The term “point cloud (PC) sample” may refer to a frame, a sub-region within a frame, a slice, a tile, or any other suitable processing unit containing one or more nodes or points.

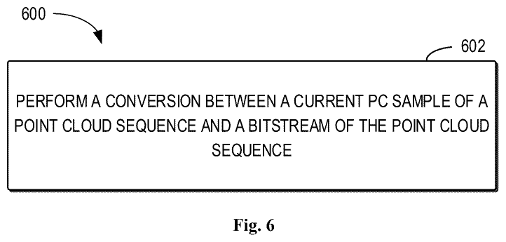

FIG. 6 illustrates a flowchart of a method 600 for point cloud coding in accordance with some embodiments of the present disclosure. As shown in FIG. 6, at 602, a conversion between a current point cloud (PC) sample of a point cloud sequence and a bitstream of the point cloud sequence is performed. In some embodiments the conversion may include encoding the current PC sample into the bitstream. Alternatively or additionally, the conversion may include decoding the current PC sample from the bitstream.

In addition, the bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level. The first set of attribute prediction schemes and/the second set of attribute prediction schemes may comprise one or more attribute prediction schemes. In addition, the first set of attribute prediction schemes is actually used for coding the one or more nodes at the first level, while one or more of the second set of attribute prediction schemes may be not used for coding the one or more nodes that the first level.

By way of example rather than limitation, the first level may be a frame level, a depth layer level, a region level, or a node level. As used herein, a node in a PC sample is an element of a tree structure for spatial partition of the PC sample. A depth layer of a tree structure refers to a set of nodes at the same depth in the tree structure, and a depth of a node is defined as the number of descendent hops from the root node to the node. A depth layer may also be referred to as a tree level. For example, if the first level is a frame level, the one or more nodes at the frame level may comprise all nodes in a frame. If the first level is a depth layer level, the one or more nodes at the depth layer level may comprise all of nodes that are at a specific depth layer. A region may comprise a part of nodes at a specific depth layer.

As used herein, an attribute prediction scheme is configured for determining a prediction associated with attribute information of a node. In one example embodiment, the prediction associated with the attribute information may comprise a prediction of the attribute information. In this case, at an encoder side, the prediction of the attribute information of the node may be determined based on attribute information of at least one reference node, a residual of the attribute information may be derived based on the attribute information and the prediction of the attribute information, and an RAHT may be performed on the residual of the attribute information.

In an alternative example embodiment, the prediction associated with the attribute information may comprise a prediction of a first coefficient for the attribute information, and the first coefficient is a result of performing an RAHT on the attribute information. By way of example, the first coefficient may be an alternating current (AC) coefficient or a direct current (DC) coefficient. In this case, the prediction of the first coefficient for the attribute information of the node may be determined based on a first coefficient for attribute information of a reference node, and a residual is derived based on the first coefficient for the attribute information of the node and the prediction.

In view of the above, the bitstream comprises an indication indicating an attribute prediction scheme(s) that is used and/or available for one or more nodes in the current PC sample that are at a first level lower than a sequence level. Compared with the conventional solution where information regarding the usage of attribute prediction scheme(s) is signaled at sequence level, the proposed method can advantageously signal such information at a lower level, and enable a refined control of the usage of attribute prediction scheme(s). Thereby, the coding efficiency and coding quality can be improved.

In some embodiments, the bitstream may further comprise a second indication indicating whether a first attribute prediction scheme is available for nodes at the sequence level. In the first attribute prediction scheme, a prediction associated with attribute information of a node is determined based on a weighted average of a first prediction associated with the attribute information that is determined based on an inter prediction scheme and a second prediction associated with the attribute information that is determined based on an intra prediction scheme.

In some embodiments, the second set of attribute prediction schemes may comprise at least one of the following: an inter prediction scheme associated with attribute information, an intra prediction scheme associated with attribute information, or a first attribute prediction scheme configured for determining a prediction associated with attribute information of a node based on a weighted average of a first prediction associated with the attribute information that is determined based on the inter prediction scheme and a second prediction associated with the attribute information that is determined based on the intra prediction scheme.

In some embodiments, a target prediction associated with attribute information of a node may be determined based on predictions that are determined based on the second set of attribute prediction schemes. In one example embodiment, if a first prediction associated with the attribute information that is determined based on the inter prediction scheme is not zero, the target prediction is equal to the first prediction. If the first prediction is zero, the target prediction is equal to a second prediction associated with the attribute information that is determined based on the intra prediction scheme.

In another example embodiment, if a first prediction associated with the attribute information is determined based on the inter prediction scheme, the target prediction is equal to the first prediction. If the first prediction is not determined, the target prediction is equal to a second prediction associated with the attribute information that is determined based on the intra prediction scheme.

In a further example embodiment, if a first prediction associated with the attribute information that is determined based on the inter prediction scheme is zero, the target prediction is equal to a second prediction associated with the attribute information that is determined based on the intra prediction scheme. If the first prediction is not zero, the target prediction is equal to a weighted average of the first prediction and the second prediction.

In a still further example embodiment, if a first prediction associated with the attribute information that is determined based on the inter prediction scheme is not zero and a second prediction associated with the attribute information that is determined based on the intra prediction scheme is not zero, the target prediction is equal to a weighted average of the first prediction and the second prediction. If the first prediction is zero and the second prediction is not zero, the target prediction is equal to the second prediction. If the first prediction is not zero and the second prediction is zero, the target prediction is equal to the first prediction.

In some embodiments, the bitstream may further comprise an indication indicting a set of attribute prediction schemes available for all of nodes in the point cloud sequence. Additionally or alternatively, the bitstream may further comprise an indication indicting a set of attribute prediction schemes available for all of nodes in a region of a PC sample in the point cloud sequence. In some additional or alternative embodiments, the bitstream may further comprise an indication indicting a set of attribute prediction schemes available for all of nodes at a depth layer of a PC sample in the point cloud sequence.

In some embodiments, the above mentioned indication (such as the first indication, the second indication, and/or the like) may be fixed at an encoder and a decoder. Alternatively, the indication may be determined at an encoder and a decoder.

In some further embodiments, the indication may be determined at an encoder. For example, the indication may be determined based on motion information for a PC sample. By way of example, if the motion information is smaller than a threshold, a first attribute prediction scheme is not used for coding the PC sample. The first attribute prediction scheme is configured for determining a prediction associated with attribute information of a node in the PC sample based on a weighted average of a first prediction associated with the attribute information that is determined based on an inter prediction scheme and a second prediction associated with the attribute information that is determined based on an intra prediction scheme. In some additional embodiments, the indication may be signaled to a decoder.

In some embodiments, information regarding whether to disable an intra prediction scheme for an AC coefficient and/or a DC coefficient associated with attribute information of a current node in the current PC sample is determined on-the fly. For example, if an inter prediction scheme is applied and a result of the intra prediction scheme is not used to determine a target prediction of the AC coefficient and/or DC coefficient, the intra prediction scheme is disabled. Additionally or alternatively, if a result of the intra prediction scheme is not used to determine a target prediction of the AC coefficient and/or DC coefficient, the intra prediction scheme is disabled. Additionally or alternatively, if the intra prediction scheme is disabled, the number of neighbor nodes of the current node is set to be a specific value.

In some embodiments, if a spatial location of a first node in a reference PC sample of the current PC sample is the same as a current node in the current PC sample and the first node is not empty, the first node is a reference node of the current node. If at least one of the following condition is met, the first node is not a reference node of the current node: the spatial location of the first node is different from the current node, or the first node is empty.

In some alternative embodiments, if a spatial location of a first node in a reference PC sample of the current PC sample is the same as a current node in the current PC sample, the first node is a reference node of the current node. If the spatial location of the first node is different from the current node the first node is not a reference node of the current node. By way of example rather than limitation, a spatial location of a node may be represented by a Morton code of the node, a shifted Morton code of the node or the like.

In some embodiments, the second set of attribute prediction schemes may comprise an attribute prediction scheme configured for determining a prediction associated with attribute information of a node based on a weighted sum or a non-linear function of a first prediction associated with the attribute information that is determined based on the inter prediction scheme and a second prediction associated with the attribute information that is determined based on the intra prediction scheme.

In some embodiments, at least one weight for determining the weighted sum or at least one weight for determining the non-linear function is fixed at an encoder and a decoder. In some further embodiments, at least one weight for determining the weighted sum or at least one weight for determining the non-linear function is determined at an encoder and a decoder. Alternatively, at least one weight for determining the weighted sum or at least one weight for determining the non-linear function is indicated in the bitstream.

In some embodiments, at least one weight for determining the weighted sum or at least one weight for determining the non-linear function is different for different depth layers. Additionally or alternatively, at least one weight for determining the weighted sum or at least one weight for determining the non-linear function is different for different regions.

In some embodiments, a prediction of an AC coefficient for attribute information of a current node in the current PC sample may be obtained by performing an RAHT transform on reference attribute information of a reference node of the current node. The reference attribute information of the reference node may be determined based on reconstructed attribute information and reconstructed geometry information of a reference PC sample comprising the reference node. The reference attribute information of the reference node may be represented by one of the following: reference attribute information of each sub-node of the reference node, or an average of reference attribute information of sub-nodes of the reference node.

In some embodiments, a prediction of an DC coefficient for attribute information of a current node in the current PC sample may be obtained by performing an RAHT transform on reference attribute information of a reference node of the current node, the reference attribute information of the reference node is determined based on reconstructed attribute information and reconstructed geometry information of a reference PC sample comprising the reference node. The reference attribute information of the reference node is represented by one of the following: reference attribute information of each sub-node of the reference node, or an average of reference attribute information of sub-nodes of the reference node.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a point cloud sequence which is generated by a method performed by an apparatus for video processing. In the method, a conversion between a current point cloud (PC) sample of the point cloud sequence and the bitstream is performed. The bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

According to still further embodiments of the present disclosure, a method for storing bitstream of a point cloud sequence is provided. In the method, a conversion between a current point cloud (PC) sample of the point cloud sequence and the bitstream is performed, and the bitstream is stored in a non-transitory computer-readable recording medium. The bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

Implementations of the present disclosure can be described in view of the following clauses, the features of which can be combined in any reasonable manner.

Clause 1. A method for point cloud coding, comprising: performing a conversion between a current point cloud (PC) sample of a point cloud sequence and a bitstream of the point cloud sequence, wherein the bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

Clause 2. The method of clause 1, wherein an attribute prediction scheme is configured for determining a prediction associated with attribute information of a node.

Clause 3. The method of clause 2, wherein the prediction associated with the attribute information comprises one of the following: a prediction of a first coefficient for the attribute information, the first coefficient being a result of performing a region-adaptive hierarchical transform (RAHT) on the attribute information, or a prediction of the attribute information.

Clause 4. The method of clause 3, wherein the first coefficient is an alternating current (AC) coefficient or a direct current (DC) coefficient.

Clause 5. The method of any of clauses 1-4, wherein the first level is one of the following: a frame level, a depth layer level, a region level, or a node level.

Clause 6. The method of any of clauses 1-5, wherein the bitstream further comprises a second indication indicating whether a first attribute prediction scheme is available for nodes at the sequence level, and in the first attribute prediction scheme, a prediction associated with attribute information of a node is determined based on a weighted average of a first prediction associated with the attribute information that is determined based on an inter prediction scheme and a second prediction associated with the attribute information that is determined based on an intra prediction scheme.

Clause 7. The method of any of clauses 1-6, wherein the second set of attribute prediction schemes comprises at least one of the following: an inter prediction scheme associated with attribute information, an intra prediction scheme associated with attribute information, or a first attribute prediction scheme configured for determining a prediction associated with attribute information of a node based on a weighted average of a first prediction associated with the attribute information that is determined based on the inter prediction scheme and a second prediction associated with the attribute information that is determined based on the intra prediction scheme.

Clause 8. The method of clause 7, wherein a target prediction associated with attribute information of a node is determined based on predictions that are determined based on the second set of attribute prediction schemes.

Clause 9. The method of clause 8, wherein if a first prediction associated with the attribute information that is determined based on the inter prediction scheme is not zero, the target prediction is equal to the first prediction, or if the first prediction is zero, the target prediction is equal to a second prediction associated with the attribute information that is determined based on the intra prediction scheme.

Clause 10. The method of clause 8, wherein if a first prediction associated with the attribute information is determined based on the inter prediction scheme, the target prediction is equal to the first prediction, or if the first prediction is not determined, the target prediction is equal to a second prediction associated with the attribute information that is determined based on the intra prediction scheme.

Clause 11. The method of clause 8, wherein if a first prediction associated with the attribute information that is determined based on the inter prediction scheme is zero, the target prediction is equal to a second prediction associated with the attribute information that is determined based on the intra prediction scheme, or if the first prediction is not zero, the target prediction is equal to a weighted average of the first prediction and the second prediction.

Clause 12. The method of clause 8, wherein if a first prediction associated with the attribute information that is determined based on the inter prediction scheme is not zero and a second prediction associated with the attribute information that is determined based on the intra prediction scheme is not zero, the target prediction is equal to a weighted average of the first prediction and the second prediction, or if the first prediction is zero and the second prediction is not zero, the target prediction is equal to the second prediction, or if the first prediction is not zero and the second prediction is zero, the target prediction is equal to the first prediction.

Clause 13. The method of any of clauses 1-12, wherein the bitstream further comprises an indication indicting a set of attribute prediction schemes available for all of nodes in the point cloud sequence.

Clause 14. The method of any of clauses 1-13, wherein the bitstream further comprises an indication indicting a set of attribute prediction schemes available for all of nodes in a region of a PC sample in the point cloud sequence.

Clause 15. The method of any of clauses 1-14, wherein the bitstream further comprises an indication indicting a set of attribute prediction schemes available for all of nodes at a depth layer of a PC sample in the point cloud sequence.

Clause 16. The method of any of clauses 1-15, wherein the indication is fixed at an encoder and a decoder.

Clause 17. The method of any of clauses 1-15, wherein the indication is determined at an encoder and a decoder.

Clause 18. The method of any of clauses 1-15, wherein the indication is determined at an encoder.

Clause 19. The method of clause 18, wherein the indication is determined based on motion information for a PC sample.

Clause 20. The method of clause 19, wherein if the motion information is smaller than a threshold, a first attribute prediction scheme is not used for coding the PC sample, and the first attribute prediction scheme is configured for determining a prediction associated with attribute information of a node in the PC sample based on a weighted average of a first prediction associated with the attribute information that is determined based on an inter prediction scheme and a second prediction associated with the attribute information that is determined based on an intra prediction scheme.

Clause 21. The method of any of clauses 1-15, wherein the indication is signaled to a decoder.

Clause 22. The method of any of clauses 1-21, wherein information regarding whether to disable an intra prediction scheme for an AC coefficient and/or a DC coefficient associated with attribute information of a current node in the current PC sample is determined on-the fly.

Clause 23. The method of clause 22, wherein if an inter prediction scheme is applied and a result of the intra prediction scheme is not used to determine a target prediction of the AC coefficient and/or DC coefficient, the intra prediction scheme is disabled.

Clause 24. The method of clause 22, wherein if a result of the intra prediction scheme is not used to determine a target prediction of the AC coefficient and/or DC coefficient, the intra prediction scheme is disabled.

Clause 25. The method of any of clauses 22-24, wherein if the intra prediction scheme is disabled, the number of neighbor nodes of the current node is set to be a specific value.

Clause 26. The method of any of clauses 1-25, wherein if a spatial location of a first node in a reference PC sample of the current PC sample is the same as a current node in the current PC sample and the first node is not empty, the first node is a reference node of the current node, and if at least one of the following condition is met, the first node is not a reference node of the current node: the spatial location of the first node is different from the current node, or the first node is empty.

Clause 27. The method of any of clauses 1-25, wherein if a spatial location of a first node in a reference PC sample of the current PC sample is the same as a current node in the current PC sample, the first node is a reference node of the current node, and if the spatial location of the first node is different from the current node the first node is not a reference node of the current node.

Clause 28. The method of any of clauses 26-27, wherein a spatial location of a node is represented by a Morton code of the node or a shifted Morton code of the node.

Clause 29. The method of any of clauses 1-28, wherein the second set of attribute prediction schemes comprises an attribute prediction scheme configured for determining a prediction associated with attribute information of a node based on a weighted sum or a non-linear function of a first prediction associated with the attribute information that is determined based on the inter prediction scheme and a second prediction associated with the attribute information that is determined based on the intra prediction scheme.

Clause 30. The method of clause 29, wherein at least one weight for determining the weighted sum or at least one weight for determining the non-linear function is fixed at an encoder and a decoder.

Clause 31. The method of clause 29, wherein at least one weight for determining the weighted sum or at least one weight for determining the non-linear function is determined at an encoder and a decoder.

Clause 32. The method of clause 29, wherein at least one weight for determining the weighted sum or at least one weight for determining the non-linear function is indicated in the bitstream.

Clause 33. The method of any of clauses 29-32, wherein at least one weight for determining the weighted sum or at least one weight for determining the non-linear function is different for different depth layers.

Clause 34. The method of any of clauses 29-32, wherein at least one weight for determining the weighted sum or at least one weight for determining the non-linear function is different for different regions.

Clause 35. The method of any of clauses 1-34, wherein a prediction of an AC coefficient for attribute information of a current node in the current PC sample is obtained by performing an RAHT transform on reference attribute information of a reference node of the current node, the reference attribute information of the reference node is determined based on reconstructed attribute information and reconstructed geometry information of a reference PC sample comprising the reference node, and the reference attribute information of the reference node is represented by one of the following: reference attribute information of each sub-node of the reference node, or an average of reference attribute information of sub-nodes of the reference node.

Clause 36. The method of any of clauses 1-34, wherein a prediction of an DC coefficient for attribute information of a current node in the current PC sample is obtained by performing an RAHT transform on reference attribute information of a reference node of the current node, the reference attribute information of the reference node is determined based on reconstructed attribute information and reconstructed geometry information of a reference PC sample comprising the reference node, and the reference attribute information of the reference node is represented by one of the following: reference attribute information of each sub-node of the reference node, or an average of reference attribute information of sub-nodes of the reference node.

Clause 37. The method of any of clauses 1-36, wherein a PC sample is one of the following: a frame, a slice, a tile, or a unit containing one or more nodes or points.

Clause 38. The method of any of clauses 1-37, wherein a node in a PC sample is an element of a tree structure for spatial partition of the PC sample.

Clause 39. The method of any of clauses 1-38, wherein the conversion includes encoding the current PC sample into the bitstream.

Clause 40. The method of any of clauses 1-38, wherein the conversion includes decoding the current PC sample from the bitstream.

Clause 41. An apparatus for video processing comprising a processor and a non-transitory memory with instructions thereon, wherein the instructions upon execution by the processor, cause the processor to perform a method in accordance with any of clauses 1-40.

Clause 42. A non-transitory computer-readable storage medium storing instructions that cause a processor to perform a method in accordance with any of clauses 1-40.

Clause 43. A non-transitory computer-readable recording medium storing a bitstream of a point cloud sequence which is generated by a method performed by an apparatus for video processing, wherein the method comprises: performing a conversion between a current point cloud (PC) sample of the point cloud sequence and the bitstream, wherein the bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

Clause 44. A method for storing a bitstream of a point cloud sequence, comprising: performing a conversion between a current point cloud (PC) sample of the point cloud sequence and the bitstream; and storing the bitstream in a non-transitory computer-readable recording medium, wherein the bitstream comprises a first indication indicating at least one of the following: a first set of attribute prediction schemes used for one or more nodes in the current PC sample that are at a first level lower than a sequence level, or a second set of attribute prediction schemes available for one or more nodes in the current PC sample that are at the first level.

### Example Device

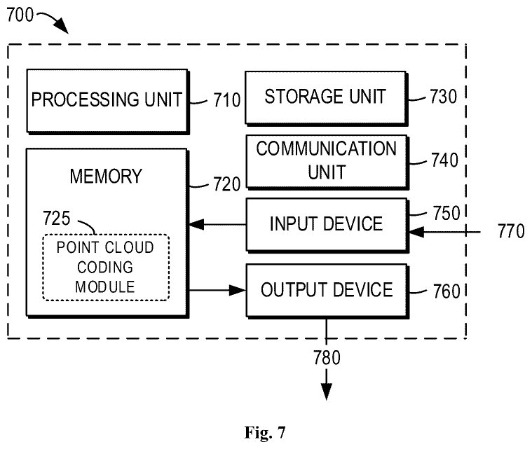

FIG. 7 illustrates a block diagram of a computing device 700 in which various embodiments of the present disclosure can be implemented. The computing device 700 may be implemented as or included in the source device 110 (or the GPCC encoder 116 or 200) or the destination device 120 (or the GPCC decoder 126 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet. Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache. Random Access Memory (RAM)), a non-volatile memory (such as a Read-Only Memory (ROM). Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement point cloud encoding/decoding in embodiments of the present disclosure. The memory 720 may include one or more point cloud coding modules 725 having one or more program instructions. These modules are accessible and executable by the processing unit 710 to perform the functionalities of the various embodiments described herein.

In the example embodiments of performing point cloud encoding, the input device 750 may receive point cloud data as an input 770 to be encoded. The point cloud data may be processed, for example, by the point cloud coding module 725, to generate an encoded bitstream. The encoded bitstream may be provided via the output device 760 as an output 780.

In the example embodiments of performing point cloud decoding, the input device 750 may receive an encoded bitstream as the input 770. The encoded bitstream may be processed, for example, by the point cloud coding module 725, to generate decoded point cloud data. The decoded point cloud data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
performing a conversion between a current point cloud (PC) sample of a point cloud sequence and a bitstream of the point cloud sequence, wherein the bitstream comprises a first indication indicating at least one of the following:
a first set of attribute prediction schemes used for one or more nodes in the current PC sample that are at a first level lower than a sequence level, or
a second set of attribute prediction schemes available for one or more nodes in the current PC sample that are at the first level.

2. The method of claim 1, wherein an attribute prediction scheme is configured for determining a prediction associated with attribute information of a node,
wherein the prediction associated with the attribute information comprises one of the following:
a prediction of a first coefficient for the attribute information, the first coefficient being a result of performing a region-adaptive hierarchical transform (RAHT) on the attribute information, or
a prediction of the attribute information,
wherein the first coefficient is an alternating current (AC) coefficient or a direct current (DC) coefficient.

3. The method of claim 1, wherein the first level is one of the following:
a frame level,
a depth layer level,
a region level, or
a node level.

4. The method of claim 1, wherein the bitstream further comprises a second indication indicating whether a first attribute prediction scheme is available for nodes at the sequence level, and
wherein in the first attribute prediction scheme, a prediction associated with attribute information of a node is determined based on a weighted average of a first prediction associated with the attribute information that is determined based on an inter prediction scheme and a second prediction associated with the attribute information that is determined based on an intra prediction scheme.

5. The method of claim 1, wherein the second set of attribute prediction schemes comprises at least one of the following:
an inter prediction scheme associated with attribute information,
an intra prediction scheme associated with attribute information, or
a first attribute prediction scheme configured for determining a prediction associated with attribute information of a node based on a weighted average of a first prediction associated with the attribute information that is determined based on the inter prediction scheme and a second prediction associated with the attribute information that is determined based on the intra prediction scheme,
wherein a target prediction associated with attribute information of a node is determined based on predictions that are determined based on the second set of attribute prediction schemes.

6. The method of claim 5, wherein if a first prediction associated with the attribute information that is determined based on the inter prediction scheme is not zero, the target prediction is equal to the first prediction, or
if the first prediction is zero, the target prediction is equal to a second prediction associated with the attribute information that is determined based on the intra prediction scheme.

7. The method of claim 5, wherein if a first prediction associated with the attribute information is determined based on the inter prediction scheme, the target prediction is equal to the first prediction, or
if the first prediction is not determined, the target prediction is equal to a second prediction associated with the attribute information that is determined based on the intra prediction scheme.

8. The method of claim 5, wherein if a first prediction associated with the attribute information that is determined based on the inter prediction scheme is zero, the target prediction is equal to a second prediction associated with the attribute information that is determined based on the intra prediction scheme, or
if the first prediction is not zero, the target prediction is equal to a weighted average of the first prediction and the second prediction.

9. The method of claim 5, wherein if a first prediction associated with the attribute information that is determined based on the inter prediction scheme is not zero and a second prediction associated with the attribute information that is determined based on the intra prediction scheme is not zero, the target prediction is equal to a weighted average of the first prediction and the second prediction, or
if the first prediction is zero and the second prediction is not zero, the target prediction is equal to the second prediction, or
if the first prediction is not zero and the second prediction is zero, the target prediction is equal to the first prediction.

10. The method of claim 1, wherein the bitstream further comprises an indication indicting a set of attribute prediction schemes available for all of nodes in the point cloud sequence, and/or
wherein the bitstream further comprises an indication indicting a set of attribute prediction schemes available for all of nodes in a region of a PC sample in the point cloud sequence, and/or
wherein the bitstream further comprises an indication indicting a set of attribute prediction schemes available for all of nodes at a depth layer of a PC sample in the point cloud sequence.

11. The method of claim 1, wherein the indication is fixed at an encoder and a decoder, or
wherein the indication is determined at an encoder and a decoder, or
wherein the indication is signaled to a decoder, or
wherein the indication is determined at an encoder, wherein the indication is determined based on motion information for a PC sample, and wherein if the motion information is smaller than a threshold, a first attribute prediction scheme is not used for coding the PC sample, and the first attribute prediction scheme is configured for determining a prediction associated with attribute information of a node in the PC sample based on a weighted average of a first prediction associated with the attribute information that is determined based on an inter prediction scheme and a second prediction associated with the attribute information that is determined based on an intra prediction scheme.

12. The method of claim 1, wherein information regarding whether to disable an intra prediction scheme for an AC coefficient and/or a DC coefficient associated with attribute information of a current node in the current PC sample is determined on-the fly,
wherein if an inter prediction scheme is applied and a result of the intra prediction scheme is not used to determine a target prediction of the AC coefficient and/or DC coefficient, the intra prediction scheme is disabled, or
wherein if a result of the intra prediction scheme is not used to determine a target prediction of the AC coefficient and/or DC coefficient, the intra prediction scheme is disabled, and/or
wherein if the intra prediction scheme is disabled, the number of neighbor nodes of the current node is set to be a specific value.

13. The method of claim 1, wherein if a spatial location of a first node in a reference PC sample of the current PC sample is the same as a current node in the current PC sample and the first node is not empty, the first node is a reference node of the current node, and if at least one of the following condition is met, the first node is not a reference node of the current node: the spatial location of the first node is different from the current node, or the first node is empty, or
wherein if a spatial location of a first node in a reference PC sample of the current PC sample is the same as a current node in the current PC sample, the first node is a reference node of the current node, and if the spatial location of the first node is different from the current node the first node is not a reference node of the current node, wherein a spatial location of a node is represented by a Morton code of the node or a shifted Morton code of the node.

14. The method of claim 1, wherein the second set of attribute prediction schemes comprises an attribute prediction scheme configured for determining a prediction associated with attribute information of a node based on a weighted sum or a non-linear function of a first prediction associated with the attribute information that is determined based on the inter prediction scheme and a second prediction associated with the attribute information that is determined based on the intra prediction scheme,
wherein at least one weight for determining the weighted sum or at least one weight for determining the non-linear function is fixed at an encoder and a decoder, or
wherein at least one weight for determining the weighted sum or at least one weight for determining the non-linear function is determined at an encoder and a decoder, or
wherein at least one weight for determining the weighted sum or at least one weight for determining the non-linear function is indicated in the bitstream, and/or
wherein at least one weight for determining the weighted sum or at least one weight for determining the non-linear function is different for different depth layers, or
wherein at least one weight for determining the weighted sum or at least one weight for determining the non-linear function is different for different regions.

15. The method of claim 1, wherein a prediction of an AC coefficient for attribute information of a current node in the current PC sample is obtained by performing an RAHT transform on reference attribute information of a reference node of the current node, the reference attribute information of the reference node is determined based on reconstructed attribute information and reconstructed geometry information of a reference PC sample comprising the reference node, and the reference attribute information of the reference node is represented by one of the following: reference attribute information of each sub-node of the reference node, or an average of reference attribute information of sub-nodes of the reference node, or
wherein a prediction of an DC coefficient for attribute information of a current node in the current PC sample is obtained by performing an RAHT transform on reference attribute information of a reference node of the current node, the reference attribute information of the reference node is determined based on reconstructed attribute information and reconstructed geometry information of a reference PC sample comprising the reference node, and the reference attribute information of the reference node is represented by one of the following: reference attribute information of each sub-node of the reference node, or an average of reference attribute information of sub-nodes of the reference node.

16. The method of claim 1, wherein a PC sample is one of the following: a frame, a slice, a tile, or a unit containing one or more nodes or points, and/or
wherein a node in a PC sample is an element of a tree structure for spatial partition of the PC sample.

17. The method of claim 1, wherein the conversion includes encoding the current PC sample into the bitstream, or
wherein the conversion includes decoding the current PC sample from the bitstream.

18. An apparatus for video processing comprising a processor and a non-transitory memory with instructions thereon, wherein the instructions upon execution by the processor, cause the processor to:
perform a conversion between a current point cloud (PC) sample of a point cloud sequence and a bitstream of the point cloud sequence, wherein the bitstream comprises a first indication indicating at least one of the following:
a first set of attribute prediction schemes used for one or more nodes in the current PC sample that are at a first level lower than a sequence level, or
a second set of attribute prediction schemes available for one or more nodes in the current PC sample that are at the first level.

19. A non-transitory computer-readable storage medium storing instructions that cause a processor to perform operations comprising:
performing a conversion between a current point cloud (PC) sample of a point cloud sequence and a bitstream of the point cloud sequence, wherein the bitstream comprises a first indication indicating at least one of the following:
a first set of attribute prediction schemes used for one or more nodes in the current PC sample that are at a first level lower than a sequence level, or
a second set of attribute prediction schemes available for one or more nodes in the current PC sample that are at the first level.

20. A non-transitory computer-readable recording medium storing a bitstream of a point cloud sequence which is generated by a method performed by an apparatus for video processing, wherein the method comprises:
generating the bitstream of the point cloud sequence from a current point cloud (PC) sample of the point cloud sequence, wherein the bitstream comprises a first indication indicating at least one of the following:
a first set of attribute prediction schemes used for one or more nodes in the current PC sample that are at a first level lower than a sequence level, or
a second set of attribute prediction schemes available for one or more nodes in the current PC sample that are at the first level.
